(19) United States
(12) Patent Application Publication
(10) Pub. No.: US 2019/0278505 A1
(43) Pub. Date: Sep. 12, 2019

(54) MANAGEMENT APPARATUS, MANAGEMENT METHOD, AND NON-TRANSITORY COMPUTER-READABLE STORAGE MEDIUM FOR STORING PROGRAM

(71) Applicant: FUJITSU LIMITED, Kawasaki-shi (JP)

(72) Inventor: Katsuhiko Ono, Yokohama (JP)

(73) Assignee: FUJITSU LIMITED, Kawasaki-shi (JP)

(21) Appl. No.: 16/268,048

(22) Filed: Feb. 5, 2019

(30) Foreign Application Priority Data
Mar. 12, 2018 (JP) 2018-044772

(51) Int. Cl. G06F 3/06; G06F 9/48; G06F 9/455; G06F 1/28

(52) U.S. Cl. CPC G06F 3/0647; G06F 3/0604; G06F 3/0664; G06F 3/0673; G06F 2009/45575; G06F 9/45558; G06F 1/28; G06F 2009/45595; G06F 2009/4557; G06F 9/4881

(57) ABSTRACT

A method for managing a plurality of information processing apparatuses configured to run one or more virtual machines and being coupled to an uninterruptible power supply, the method includes: acquiring a priority for each virtual machine set based on a past resource usage amount for each virtual machine in a detected time period when it is detected that power is being supplied from a storage battery in the uninterruptible power supply to the plurality of information processing apparatuses; selecting a stop candidate from the virtual machines based on a current resource usage amount for each virtual machine; calculating the number of the virtual machines to stop, based on a remaining amount of the storage battery; identifying a stop target virtual machine in accordance with the number of the virtual machines; and outputting a first instruction to a first information processing apparatus associated with the stop target virtual machine.

### CROSS-REFERENCE TO RELATED APPLICATION

This application is based upon and claims the benefit of priority of the prior Japanese Patent Application No. 2018-44772, filed on Mar. 12, 2018, the entire contents of which are incorporated herein by reference.

### FIELD

The embodiment discussed herein is related to a management apparatus, a management method, and a non-transitory computer-readable storage medium for storing a program.

### BACKGROUND

In an event of a power outage due to a natural disaster or the like and supply of power to a server is interrupted, there is a possibility that a virtual machine running on the server stops, further causing data corruption and device failure. Therefore, an uninterruptible power supply (UPS) is used to supply power to the server for a certain period of time even if a power outage occurs.

As a related technique, a technique for analyzing log data so as to obtain an optimum uninterruptible power supply process according to a user has been proposed (see, for example, Japanese Laid-open Patent Publication No. 2002-218671).

In addition, as a related technique, a technique for grouping a plurality of uninterruptible power supplies for each power supply load apparatus that supplies power and transmitting a shutdown signal to the uninterruptible power supplies that have detected an abnormality has been proposed (see, for example, Japanese Laid-open Patent Publication No. 2006-172276).

In addition, as a related technique, a technique for determining a shutdown processing start timing of a server apparatus based on time for shutdown processing of the server apparatus and outputting a shutdown signal has been proposed (see, for example, Japanese Laid-open Patent Publication No. 2012-038033).

In addition, as a related technique, a technique for shifting a virtual machine providing a service to concentrate processing on a server in a predetermined rack among a rack group in a server room and stopping a rack having no running server has been proposed (see, for example, Japanese Laid-open Patent Publication No. 2011-082799).

### SUMMARY

According to an aspect of the embodiments, a method for managing a plurality of information processing apparatuses, each of the plurality of information processing apparatuses being configured to run one or more virtual machines and being coupled to an uninterruptible power supply, the method includes: executing acquisition processing that includes acquiring a priority for each virtual machine set based on a past resource usage amount for each virtual machine in a detected time period from a storage unit in a case where it is detected that power is being supplied from a storage battery in the uninterruptible power supply to the plurality of information processing apparatuses; executing selection processing that includes selecting a stop candidate from the virtual machines based on a current resource usage amount for each virtual machine; executing calculation processing that includes calculating the number of the virtual machines to stop, based on a remaining amount of the storage battery; executing identification processing that includes identifying a stop target virtual machine in accordance with the number of the virtual machines in order from the virtual machine having a lower priority among the virtual machines selected as the stop candidate; and executing stop instruction processing that includes outputting a first instruction to a first information processing apparatus associated with the stop target virtual machine, the first instruction being configured to cause the first information processing apparatus to stop running a virtual machine identified as the stop target virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example in which a plurality of servers stop at the same time after a power outage occurs;

FIG. 2 is a diagram illustrating an example of the overall configuration of the system of the embodiment;

FIG. 3 is a diagram illustrating an example of a management server;

FIG. 4 is a diagram illustrating an example of a resource usage amount for each time period of VM;

FIG. 5 is a diagram illustrating an example of priority information for each time period of VM;

FIG. 6 is a diagram illustrating an example of power supply information;

FIG. 7 is a diagram illustrating an example of VM host information;

FIG. 8 is a diagram illustrating an example of VM information;

FIG. 9 is a flowchart (part 1) illustrating an example of processing by the management server;

FIG. 10 is a flowchart (part 2) illustrating an example of processing by the management server;

FIG. 11 is a flowchart illustrating an example of power supply determination processing;

FIG. 12 is a flowchart illustrating an example of initialization processing;

FIG. 13 is a view illustrating an example of stop target VM host selection processing;

FIG. 14 is a flowchart illustrating an example of stop candidate VM selection processing;

FIG. 15 is a flowchart illustrating an example of VM stop process;

FIG. 16 is a flowchart illustrating an example of VM migration processing;

FIG. 17 is a diagram illustrating stop timing of each server after occurrence of a power outage in a case where the processing of the embodiment is applied; and

FIG. 18 is a diagram illustrating an example of a hardware configuration of the management server.

### DESCRIPTION OF EMBODIMENTS

However, even if a UPS is used in the event of a power outage, in a case where the power outage becomes longer than the time when power may be supplied by the UPS, there is a possibility that a virtual machine running on a server stops, further causing data corruption and equipment failure.

Since it is difficult to predict the power outage time, it is conceivable to shut down the server immediately after a power outage occurs. If shutdown is normally completed, data corruption and equipment failure may be avoided. However, in the case of shutting down the server immediately after a power outage occurs, even in the case of a power outage for a short period of time, since running virtual machines are stopped by shutting down the server, there is a high possibility that the work using the virtual machines will be hindered.

In one aspect, the embodiment aims to run a virtual machine with a high priority for a long time when a power outage occurs.

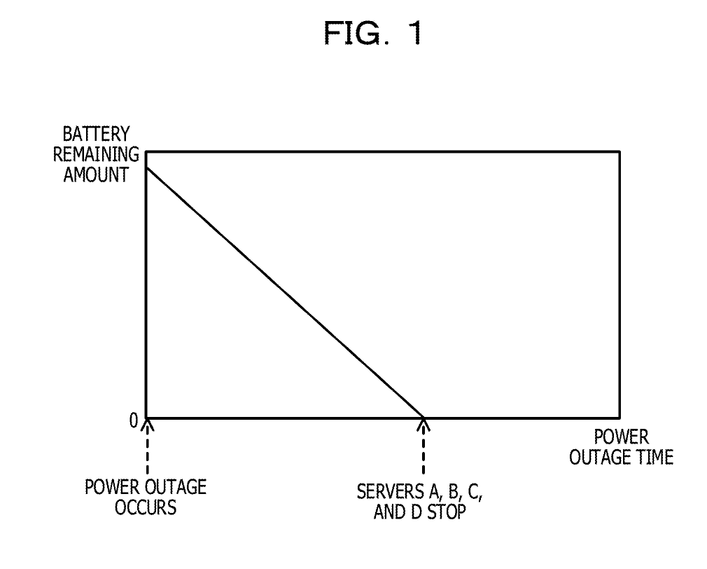

Hereinafter, an embodiment will be described in detail with reference to drawings. FIG. 1 is a diagram illustrating an example in which a plurality of servers stop at the same time after a power outage occurs.

In the example illustrated in FIG. 1, it is illustrated that a plurality of servers (servers A, B, C, and D) are connected to an uninterruptible power supply (UPS) device and run by power supply from a storage battery of the UPS after a power outage occurs. Then, in a case where a remaining amount of the storage battery of the UPS becomes 0 after a predetermined time has elapsed since a power outage occurred, all servers stop.

In the example illustrated in FIG. 1, since the priority of virtual machines running on the server is not considered, each server stops at the same timing regardless of the priority of the virtual machines running on the server.

If the power outage is recovered before the remaining amount of the battery becomes 0, it is possible to provide a service without stopping each server. However, if the remaining amount of the battery becomes 0 before the power outage is recovered, the power supply suddenly stops, which may result in data corruption in the server or hardware failure of the server. Also, it is difficult to predict the power outage time.

If a UPS with large battery capacity is used, the possibility of stopping the server due to the shortage of the battery capacity may be reduced, but since the UPS with large battery capacity is expensive, the introduction cost increases.

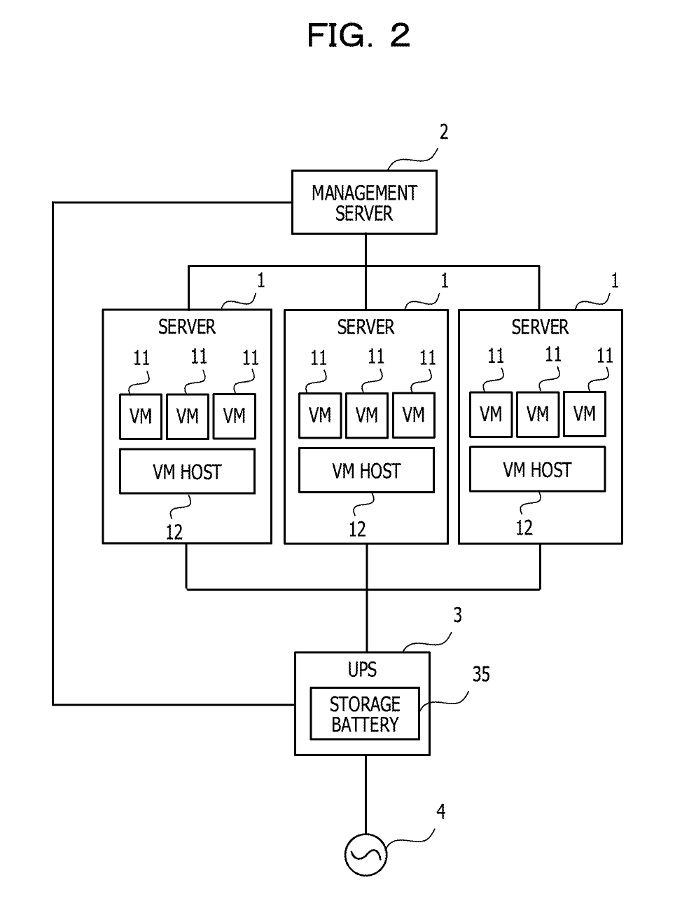

FIG. 2 is a diagram illustrating an example of the overall configuration of the system of the embodiment. The system according to the embodiment includes a plurality of servers 1, a management server 2, a UPS 3, and a system power supply 4.

The server 1 is equipped with a VM host 12, and one or a plurality of virtual machines (VMs) 11 are running on the VM host 12. The server 1 is an example of an information processing apparatus. The VM host 12 is, for example, server virtualization software operating on the server 1 in order to operate the VM 11.

The management server 2 manages the VM 11 and the VM host 12 running on the plurality of servers 1. The management server 2 is an example of a management apparatus and a computer.

The UPS 3 includes a storage battery 35. The UPS 3 supplies power to each server 1 from storage battery 35 in the case detecting a power outage of the system power supply 4. The UPS 3 outputs the power input from the system power supply 4 to each server 1 in a case where there is no power outage of the system power supply 4.

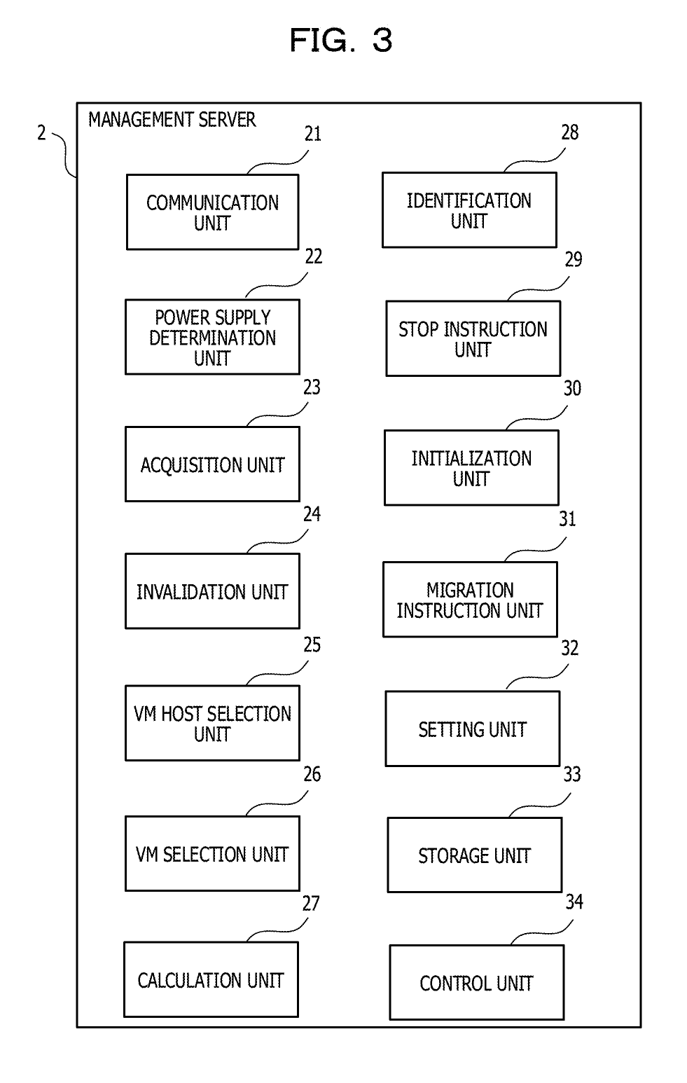

FIG. 3 is a diagram illustrating an example of the management server 2. The management server 2 includes a communication unit 21, a power supply determination unit 22, an acquisition unit 23, an invalidation unit 24, a VM host selection unit 25, a VM selection unit 26, a calculation unit 27, an identification unit 28, a stop instruction unit 29, an initialization unit 30, a migration instruction unit 31, a setting unit 32, a storage unit 33, and a control unit 34.

The communication unit 21 transmits or receives various information with the server 1 and the UPS 3. The power supply determination unit 22 receives a signal indicating an operation state from the UPS 3 and determines whether power is being supplied from the storage battery 35 in the UPS 3 to the server 1 or whether power is being supplied from the system power supply 4 to the server 1.

In a case where it is detected that power is being supplied from the storage battery 35 in the UPS 3 to each server 1, the acquisition unit 23 acquires the priority of each VM 11 set based on the past resource usage amount of the VM 11 in a current time period (detected time period), from the storage unit 33.

Before the migration instruction unit 31 outputs an instruction to migrate the VM 11 to the server 1, the invalidation unit 24 outputs an instruction to invalidate a load distribution function of the server 1 to each server 1 via the communication unit 21.

In a case where it is detected that power is supplied from the storage battery 35 in the UPS 3 to each server 1, the VM host selection unit 25 selects the VM host 12 having no running VM 11 as a stop target.

The VM selection unit 26 selects a stop candidate from the VM 11 based on a current resource usage amount for each VM 11. For example, in a case where any resource of the VM 11 is equal to or less than a threshold value, the VM selection unit 26 selects the VM 11 as a stop candidate. The VM selection unit 26 is an example of a selection unit.

The calculation unit 27 calculates the number of VMs 11 to stop based on the remaining amount of the storage battery 35. The calculation unit 27 calculates the number of VMs 11 to stop, for example, by calculating the number of priority groups of the VMs 11 to stop.

The identification unit 28 identifies a stop target VM 11 in accordance with the number calculated by the calculation unit 27 in order from the VM 11 having the lowest priority among the VMs 11 selected as a stop candidate. Further, the identification unit 28 generates a list of the identified VMs 11.

The stop instruction unit 29 outputs an instruction to stop the VM 11 identified by the identification unit 28 to the server 1 on which the stop target VM 11 runs.

The stop instruction unit 29 outputs an instruction to stop the VM host 12 having no running VM 11 to the server 1 on which the VM host 12 runs. In addition, after the migration instruction unit 31 outputs an instruction to migrate the VM 11 to the server 1, the stop instruction unit 29 outputs an instruction to stop the VM host 12 having no running VM 11 to the server 1.

In a case where power is restored from the power outage and power is supplied from server power supply 4 to server 1, the initialization unit 30 executes initialization processing of initializing various kinds of information.

The migration instruction unit 31 acquires the resource usage amount of each VM host 12 to output an instruction to migrate the VM 11 running on the VM host 12 to another VM host 12 whose resource usage amount is larger than the resource usage amount of the VM host 12, to the server 1. The VM host 12 as a migration source is an example of a first virtual machine host, and the VM host 12 as migration destination is an example of a second virtual machine host. The migration instruction unit 31 executes live migration for migrating the VM 11, for example, without stopping the running VM 11.

For example, the migration instruction unit 31 sets the VM host 12 to be a migration source of the VM 11 in order from the VM host 12 having a small resource usage amount and sets the VM host 12 to be a migration destination of the VM 11 in order from the VM host 12 having a large resource usage amount.

For example, the setting unit 32 sets the priority based on the resource usage amount of each VM 11 in the past time period. The resource usage amount is, for example, CPU usage rate [%], memory usage rate [%], disk Input and Output (I/O) usage rate [%], or network usage rate [%].

The storage unit 33 stores a resource usage amount, priority information, power supply information, VM host information, and VM information for each time period of each VM 11 to be described later.

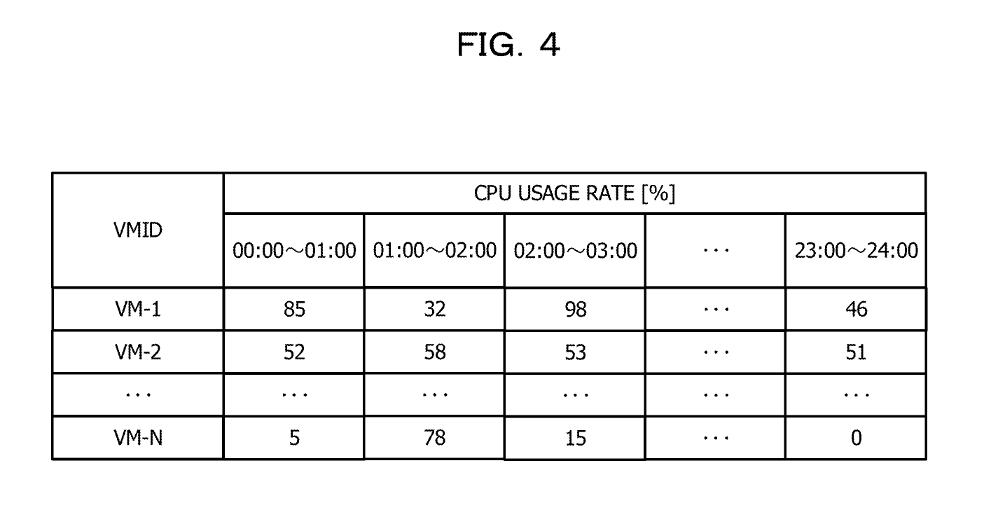

The control unit 34 executes various controls of the management server 2. FIG. 4 is a diagram illustrating an example of the resource usage amount for each time period of the VM 11. The resource usage amount is stored in the storage unit 33. The resource usage amount illustrated in FIG. 4 is the CPU usage rate [%] for each time period of each VM 11. The resource usage amount illustrated in FIG. 4 is used for determining the priority for each VM by the setting unit 32. The setting unit 32 may determine the priority based on, for example, the memory usage rate [%], the disk I/O usage rate [%], or the network usage rate [%]. In addition, the setting unit 32 may determine the priority based on a statistical value such as a total value or an average value of a plurality of resource usage amounts.

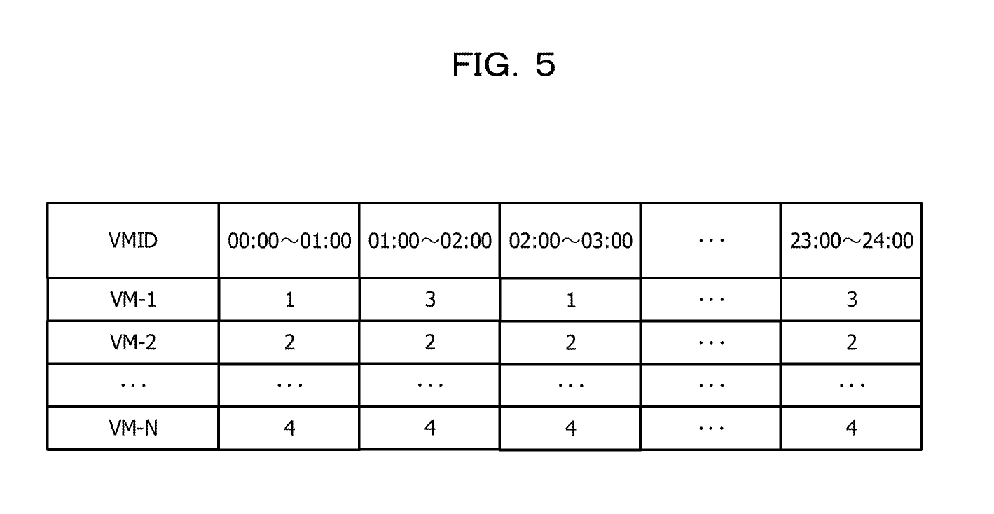

FIG. 5 is a diagram illustrating an example of priority information for each time period of VM 11. The priority information is stored in the storage unit 33. The priority illustrated in FIG. 5 is determined based on the resource usage amount illustrated in FIG. 4. For example, the setting unit 32 sets “4” as the priority in a case where the CPU usage rate is less than 25% and sets “3” as the priority in a case where the CPU usage rate is 25% or more and less than 50%. In addition, for example, the setting unit 32 sets “2” as the priority in a case where the CPU usage rate is 50% or more and less than 75% and sets “1” as the priority in a case where the CPU usage rate is 75% or more. That is, the setting unit 32 sets the priority so as to become higher as the resource usage becomes higher.

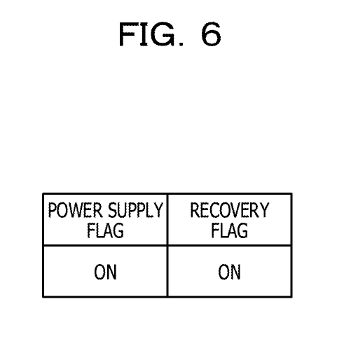

FIG. 6 is a diagram illustrating an example of power supply information. The power supply information is stored in the storage unit 33. The power supply information includes a power supply flag and a recovery flag. The power supply flag indicates a power supply state to the server 1. The recovery flag indicates whether or not the power outage is been recovered.

In a case where the power supply flag is “ON”, this indicates that power is being supplied from the system power supply 4 to the server 1. In a case where the power supply flag is “OFF”, it indicates that the system power supply 4 is in a power outage and power is being supplied from the storage battery 35 of the UPS 3 to the server 1.

In a case where the recovery flag is “ON”, this indicates that a power outage state has been recovered. After the recovery from the power outage state, when the initialization processing is completed, the recovery flag is set to “OFF”.

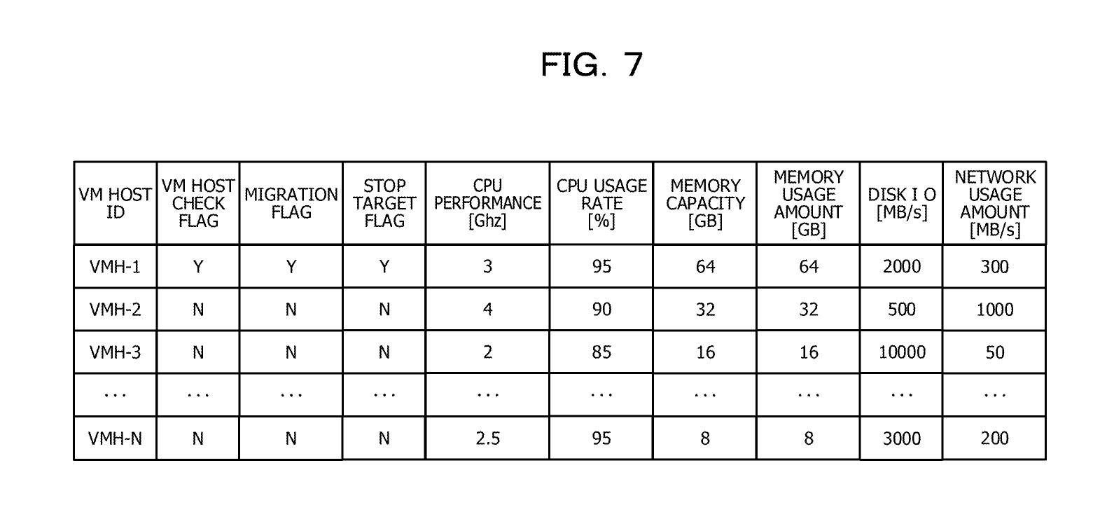

FIG. 7 is a diagram illustrating an example of VM host information. The VM host information is stored in the storage unit 33. The VM host information includes a VM host identification (ID), a VM host check flag, a migration flag, and a stop target flag. In a case where an initial value is “N” and a check is made in the stop target VM host selection processing, the VM host check flag is set to “Y”. In a case where the initial value is “N” and the VM host 12 is selected as a migration destination, the migration flag is set to “Y”. In a case where the initial value is “N” and the VM host 12 is selected as a stop target, the stop target flag is set to “Y”.

In addition, the VM host information includes resource usage amounts such as CPU performance [Ghz], CPU usage rate [Ghz], memory capacity [GB], memory usage amount [GB], disk I/O [MB/s], and network usage amount [MB/s]. In the migration processing, the migration instruction unit 31 acquires and records the resource usage amounts of all the VM hosts 12.

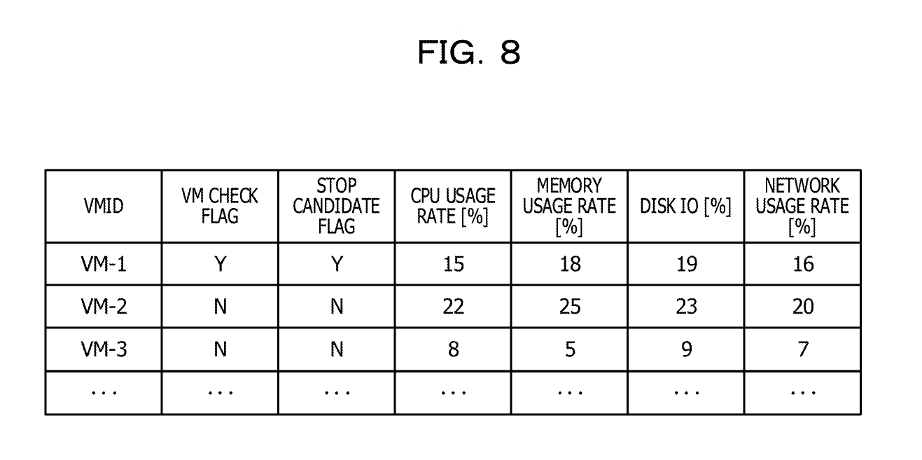

FIG. 8 is a diagram illustrating an example of VM information. The VM information is stored in the storage unit 33. The VM information includes a VMID, a VM check flag, and a stop candidate flag. In a case where the initial value is “N” and it is checked in the stop candidate VM selection processing, the VM check flag is set to “Y”. In a case where the initial value is “N” and the VM 11 is selected as a stop candidate, the stop candidate flag is set to “Y”.

In addition, the VM information includes resource usage amounts such as CPU usage rate [%], memory usage rate [%], disk I/O [%], and network usage rate [%]. In the stop candidate VM selection processing, the VM selection unit 26 acquires and records the resource usage amount of a check target VM 11.

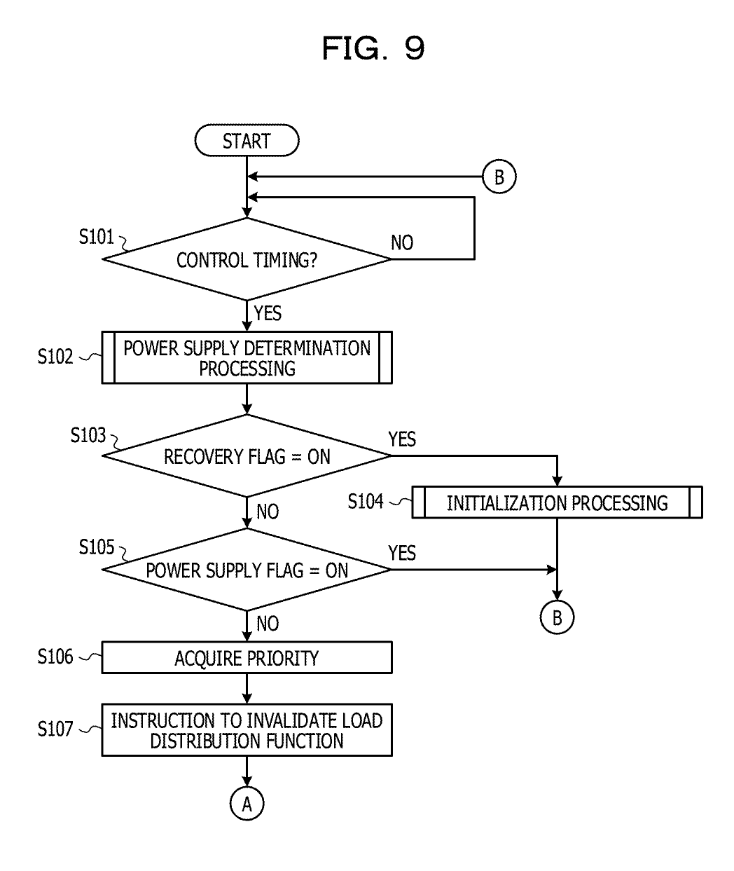

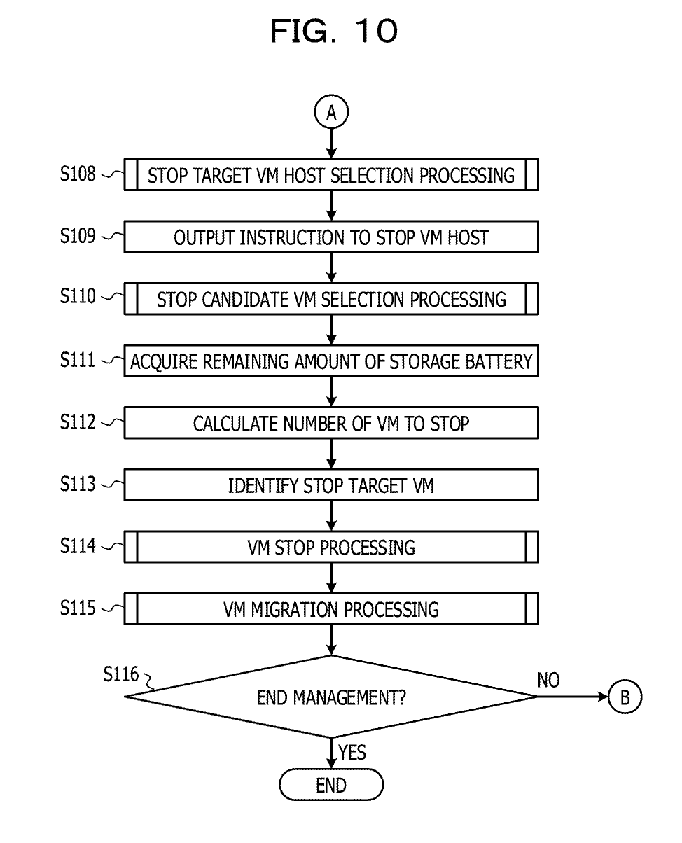

FIGS. 9 and 10 are flowcharts illustrating an example of the processing of the management server 2. The control unit 34 acquires time information from a timer and determines whether or not it is a control timing (step S101). For example, in a case where a predetermined time has elapsed from a previous control timing, the control unit 34 determines that it is a control timing. In the case of NO in step S101, the processing does not proceed to the next step.

In the case of YES in step S101, the power supply determination unit 22 executes determination processing regarding power supply to the server 1 (step S102). Details of the processing of step S102 will be described later.

The control unit 34 determines whether or not the recovery flag is “ON” (step S103). In a case where the recovery flag is “ON” (YES in step S103), it indicates that the power outage state has been recovered. In the case of YES in step S103, the initialization unit 30 executes initialization processing of initializing various information (step S104). After the processing of step S104, the processing shifts from “B” to step S101. Details of the processing of step S104 will be described later.

In a case where the recovery flag is off (NO in step S103), the control unit 34 determines whether or not the power supply flag is ON (step S105). In a case where the power supply flag is “ON” (YES in step S105), it indicates that power is being supplied from the system power supply 4 to the server 1. In the case of YES in step S105, the processing returns from “B” to step S101.

In a case where the power supply flag is “OFF” (NO in step S105), it indicates that power is being supplied from the storage battery 35 of the UPS 3 to the server 1. In the case of NO in step S105, the acquisition unit 23 acquires the priority of each VM 11 set based on the past resource usage amount of the VM 11 in the current time period from the storage unit 33 (step S106). For example, the acquisition unit 23 acquires the priority corresponding to the current time period for each VM 11 from the priority information illustrated in FIG. 5.

The invalidation unit 24 outputs an instruction to invalidate the load distribution function of the server 1 to each server 1 (step S107). The load distribution function is a function of migrating the VM 11 between servers so that the load (VM 11) is not biased to a specific server 1. In the event of a power outage, in the VM migration processing to be described later, since the processing of collecting the VM 11 is performed on the server 1 having a large resource usage amount, the invalidation unit 24 invalidates the load distribution function before the VM migration processing.

After the processing of step S107, the processing shifts from “A” to step S108 of FIG. 10. The VM host selection unit 25 executes processing of selecting a stop target VM host 12 (step S108). Details of step S108 will be described later.

The stop instruction unit 29 outputs an instruction to stop the stop target VM host 12 selected in step S108 to the server 1 on which the stop target VM host 12 is equipped (step S109). The stop instruction unit 29 refers to the VM host information illustrated in FIG. 7, for example, and outputs an instruction to stop the VM host 12 to the server 1 on which the VM host 12 whose stop target flag is “Y” runs. The stop instruction unit 29 outputs a stop instruction and returns the stop target flag of the VM host information to “N”.

The VM selection unit 26 executes processing of selecting a stop candidate VM 11 based on the current resource usage amount of each VM 11 (step S110). Details of step S110 will be described later.

The calculation unit 27 acquires the remaining amount of the storage battery 35 from the UPS 3 (step S111). Then, the calculation unit 27 calculates the number of the VMs 11 to stop based on the remaining amount of the storage battery 35 (step S112). The calculation unit 27 calculates the number of VMs 11 to stop, for example, by calculating the number of priority groups of the VMs 11 to stop.

With respect to a calculation example of the calculation unit 27, an example in a case where the total number of priority groups is “4” will be described. For example, when the remaining amount of the storage battery 35 is 75% or more, the calculation unit 27 calculates the number of priority groups of the VM 11 to stop as “0”. For example, when the remaining amount of the storage battery 35 is 50% or more and less than 75%, the calculation unit 27 calculates the number of priority groups of the VM 11 to stop as “1”. For example, when the remaining amount of the storage battery 35 is 25% or more and less than 50%, the calculation unit 27 calculates the number of priority groups of the VM 11 to stop as “2”. For example, when the remaining amount of the storage battery 35 is 0% or more and less than 25%, the calculation unit 27 calculates the number of priority groups of the VM 11 to stop as “3”. That is, the calculation unit 27 calculates the number of priority groups of the VM 11 to stop so that the number of VMs 11 that stops as the remaining amount of the storage battery 35 decreases increases.

The identification unit 28 identifies a stop target VM 11 in accordance with the number calculated by the calculation unit 27 in order from the VM 11 having the lowest priority among the VMs 11 selected as a stop candidate and generates a list of the identified VMs 11 (step S113). For example, it is assumed that an existing priority group is 1 to 4 and the number of priority groups of the VM 11 to stop calculated by the calculation unit 27 is “2”. In that case, the identification unit 28 identifies the VM 11 whose priority is “3” or “4” among the VMs 11 selected as the stop candidates as a stop target.

The stop instruction unit 29 executes VM stop processing of outputting an instruction to stop the stop target VM 11 to the server 1 (step S114). Details of the VM stop processing in step S114 will be described later.

The migration instruction unit 31 executes VM migration processing of collecting the VMs 11 to the VM host 12 having a large resource usage amount (step S115). Details of the VM migration processing in step S115 will be described later.

In a case where the management server 2 receives an instruction to end management for the server 1 (YES in step S116), the management server 2 terminates the processing. In a case where an instruction to end the management for the server 1 has not been received (NO in step S116), the processing returns from “B” to step S101 of FIG. 9.

As described above, the management server 2 selects a stop candidate VM 11 based on the current resource usage amount and stops the VM 11 in descending order of the priority set based on the past resource usage amount. If the number of the running VM 11 decreases, the power consumption also decreases. Therefore, the management server 2 may run a virtual machine with a high priority for a long time in the event of a power outage. For example, even if the current resource usage amount of the VM 11 is high, there is a possibility that the resource usage amount of the VM 11 whose past resource usage amount is low temporarily increases and the priority thereof is low. In the present embodiment, not only the current resource usage amount but also the past resource usage amount are taken into consideration for identifying a stop target VM 11, and therefore the accuracy of estimation of the priority may be improved.

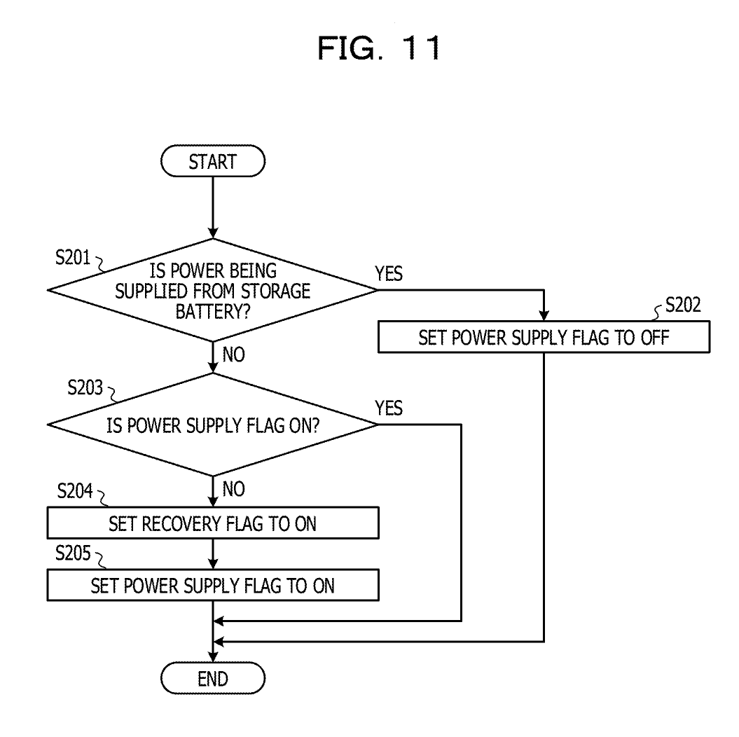

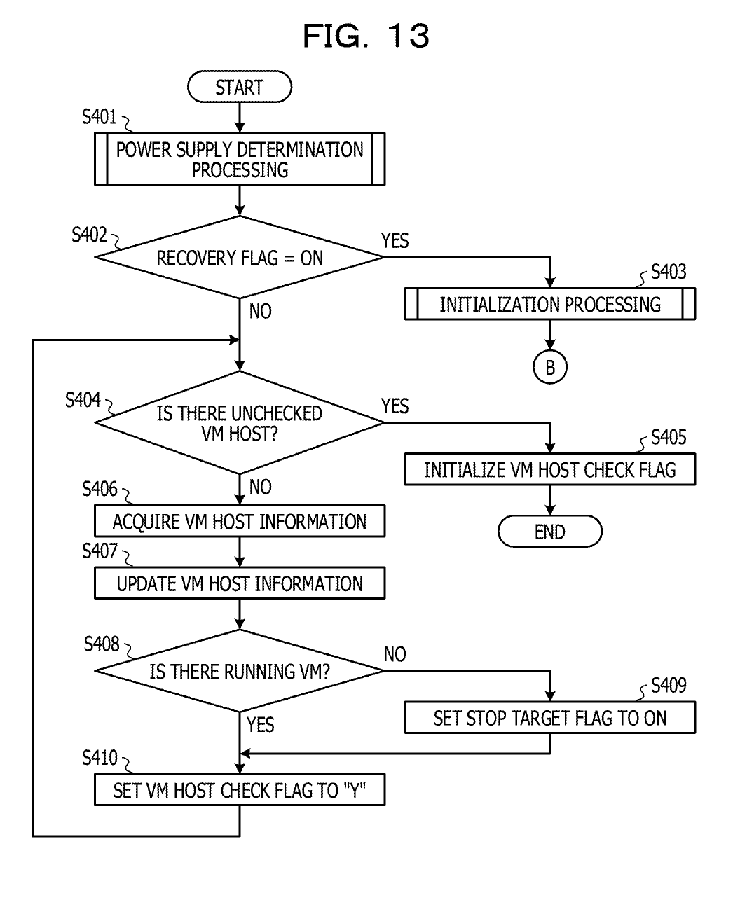

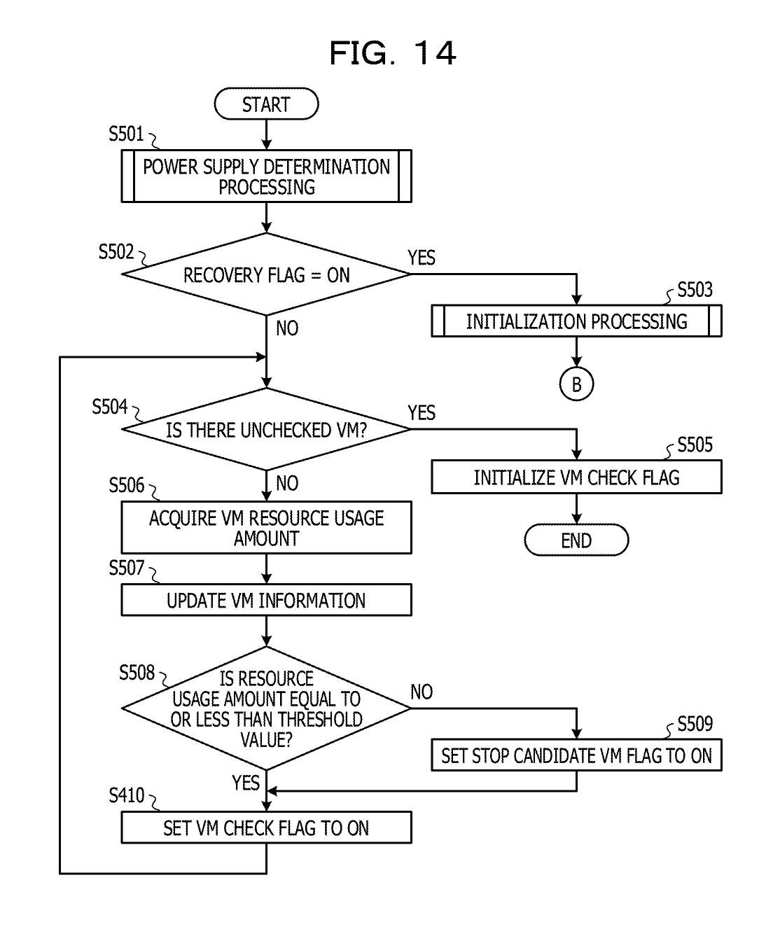

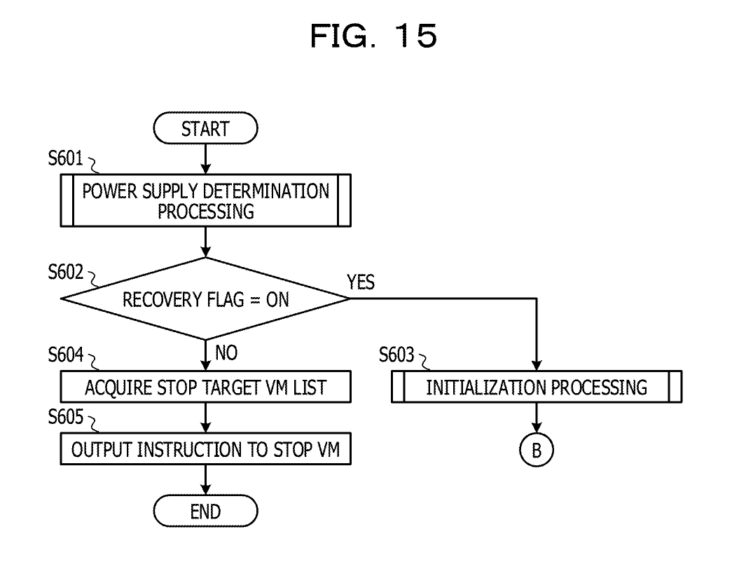

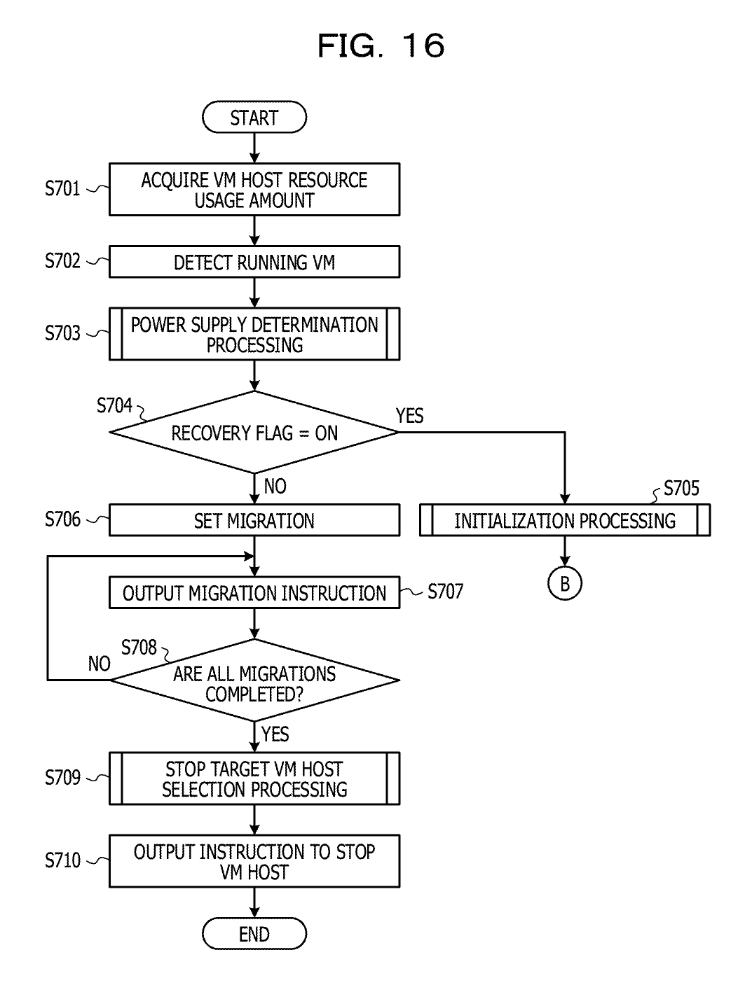

FIG. 11 is a flowchart illustrating an example of power supply determination processing. The processing illustrated in FIG. 11 corresponds to step S102 in FIG. 9, step S401 in FIG. 13, step S501 in FIG. 14, step S601 in FIG. 15, and step S703 in FIG. 16.

The power supply determination unit 22 receives a signal indicating the operation state from the UPS 3 and determines whether or not power is being supplied from the storage battery 35 of the UPS 3 to the server 1 (step S201). In the case of YES in step S201, the power supply determination unit 22 sets the power supply flag to OFF (step S202) so as to indicate that the system power supply 4 is in a power outage and power supply from the system power supply 4 is not being performed.

In the case of NO in step S201, it indicates that the system power supply 4 is not in a power outage and power supply to the server 1 is being performed from the system power supply 4. In the case of NO in step S201, the power supply determination unit 22 determines whether or not the power supply flag is ON (step S203). In a case where the power supply flag is ON (YES in step S203), the processing ends. In the case of YES in step S203, it indicates that power was being supplied from the system power supply 4 to the server 1 also in the previous control timing.

In a case where the power supply flag is not ON (NO in step S203), the power supply determination unit 22 sets the recovery flag to ON (step S204). In the case of NO in step S203, at the previous control timing, power was supplied from the storage battery 35 to the server 1 due to a power outage, but the power outage is recovered and power is being supplied from the system power supply 4 to the server 1. Then, the power supply determination unit 22 sets the power supply flag to ON (step S205).

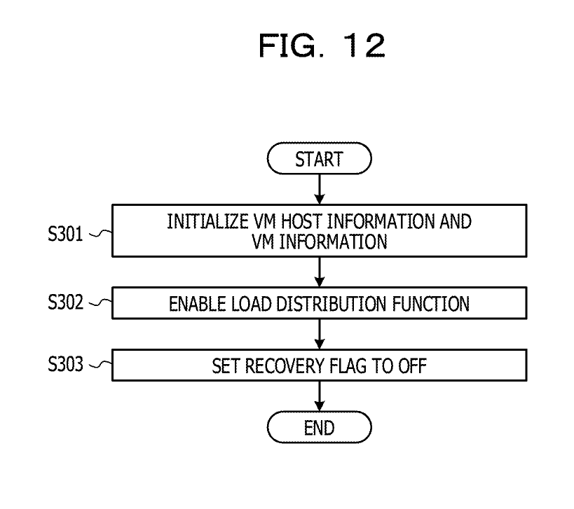

FIG. 12 is a flowchart illustrating an example of initialization processing. The initialization processing is processing performed in a case where the recovery flag is ON, that is, in a case where a power outage has been recovered. The processing illustrated in FIG. 12 corresponds to step S104 in FIG. 9, step S403 in FIG. 13, step S503 in FIG. 14, step S603 in FIG. 15, and step S705 in FIG. 16.

The initialization unit 30 initializes VM host information and VM information (step S301). For example, the initialization unit 30 changes the check flag, the migration flag, and the stop target flag of the VM host information, and the check flag and the stop candidate flag of the VM information to “N” and changes the other items to predetermined initial values.

The initialization unit 30 outputs an instruction to enable the load distribution function of the server 1 to each server 1 (step S302). In addition, the initialization unit 30 sets the recovery flag to OFF (step S303).

Through the above processing, the initialization unit 30 may return various settings and information to the state before the occurrence of a power outage.

FIG. 13 is a view illustrating an example of stop target VM host selection processing. The stop target VM host selection processing illustrated in FIG. 13 corresponds to step S108 in FIG. 10 and step S709 in FIG. 16.

The power supply determination unit 22 executes power supply determination processing (step S401). In a case where the recovery flag is ON (YES in step S402), the initialization unit 30 executes initialization processing (step S403). After step S403, the processing proceeds from “B” to step S101 of FIG. 9.

In a case where the recovery flag is not ON (NO in step S402), the VM host selection unit 25 determines whether or not there is an unchecked VM host 12 (step S404). If “N” is included in the check flag of the VM host information, the VM host selection unit 25 determines that there is an unchecked VM host 12.

In a case where there is no unchecked VM host 12 (NO in step S404), this means that all the VM hosts 12 have been checked. Therefore, the VM host selection unit 25 initializes (changes to “N”) all the VM host check flags (step S405), and the processing ends.

In the case of YES in step S404, the VM host selection unit 25 acquires the resource information of the check target VM host 12 (step S406). For example, it is assumed that the check target VM host 12 is one of the VM hosts 12 whose VM host check flag is “N”. The resource information acquired by the VM host selection unit 25 is, for example, CPU performance [Ghz], CPU usage rate [%], memory capacity [GB], memory empty [GB], disk IO [MB/s], and network usage amount [MB/s] of the VM host 12.

The VM host selection unit 25 updates the VM host information based on the acquired resource information (step S407).

The VM host selection unit 25 detects whether or not there is a VM 11 that is running on the check target VM host 12 (step S408). In a case where there is no VM 11 that is running on the check target VM host 12 (NO in step S408), the VM host selection unit 25 sets the stop target flag corresponding to the check target VM host 12 to ON (step S409). In other words, the VM host selection unit 25 selects the VM host 12 having no running VM 11 as a stop target.

In a case where there is the VM 11 that is running on the VM host 12 (YES in step S408), the VM host selection unit 25 sets the VM host check flag to “Y” (step S410) and returns to step S404.

As described above, in a case where there is no running VM 11 on the check target VM host 12, the VM host selection unit 25 selects the VM host 12 as a stop target. In addition, in a case where the VM host 12 is stopped, the server 1 on which the VM host 12 is running may stop the operation thereof. Therefore, the management server 2 may reduce consumption of the storage battery 35 and prolong the operation of the VM 11 running on the other VM host 12.

FIG. 14 is a flowchart illustrating an example of stop candidate VM selection processing. The processing illustrated in FIG. 14 corresponds to step S110 in FIG. 10.

The power supply determination unit 22 executes power supply determination processing (step S501). In a case where the recovery flag is ON (YES in step S502), the initialization unit 30 executes initialization processing (step S503). After step S503, the processing proceeds from “B” to step S101 of FIG. 9.

In a case where the recovery flag is not ON (NO in step S502), the VM selection unit 26 determines whether or not there is an unchecked VM 11 (step S504). If “N” is included in the VM check flag of the VM information, the VM selection unit 26 determines that there is an unchecked VM 11.

In a case where there is no unchecked VM 11 (NO in step S504), this means that all the VMs 11 have been checked. Therefore, the VM selection unit 26 initializes (changes to “N”) all the VM check flags (step S505), and the processing ends.

In the case of YES in step S504, the VM selection unit 26 acquires the resource usage amount of the check target VM 11 from the server 1 on which the VM 11 runs (step S506). For example, it is assumed that the check target VM 11 is one of the VM 11 whose VM check flag is “N”. The resource usage amount is, for example, CPU usage rate [%], memory usage rate [%], disk IO [%], and network usage rate [%] of the VM 11.

The VM selection unit 26 updates the VM information based on the acquired resource usage amount (step S507).

The VM selection unit 26 determines whether or not a predetermined item among the resource usage amounts of the check target VM 11 is equal to or less than a threshold value (step S508). For each item of resource usage, a threshold value is assumed to be set in advance. For example, the VM selection unit 26 compares the resource usage amount acquired in step S506 with the set threshold value. The VM selection unit 26 may determine whether or not a predetermined plurality of items among the resource usage amounts of the check target VM 11 are equal to or less than the threshold values.

In a case where the predetermined item among the resource usage amounts of the VM 11 is equal to or less than the threshold value (YES in step S508), the VM selection unit 26 sets the stop candidate VM flag to ON (step S509). The VM 11 whose one of the resources is equal to or less than the threshold is set as a stop candidate.

In a case where there is no resource usage amount equal to or less than the threshold value (NO in step S508), or after the processing in step S509, the VM selection unit 26 sets the VM check flag to ON (step S510) and returns to step S504.

As described above, the VM selection unit 26 selects a stop candidate VM 11 according to the current resource usage amount. Since it is considered that the VM 11 having a small resource usage amount has a low priority in business, the VM selection unit 26 may suppress the influence on the work due to the stop of the VM 11 by selecting the VM 11 having a small resource usage amount as a stop candidate.

FIG. 15 is a flowchart illustrating an example of VM stop process. The processing illustrated in FIG. 15 corresponds to step S114 in FIG. 10. The power supply determination unit 22 executes power supply determination processing (step S601). In a case where the recovery flag is ON (YES in step S602), the initialization unit 30 executes initialization processing (step S603). After step S603, the processing proceeds from “B” to step S101 of FIG. 9.

In a case where the recovery flag is OFF (NO in step S602), the stop instruction unit 29 acquires the list of the stop target VMs 11 identified in step S113 of FIG. 10 (step S604). The stop instruction unit 29 outputs an instruction to stop the VM 11 to the server 1 on which the stop target VM 11 runs (step S605).

FIG. 16 is a flowchart illustrating an example of VM migration processing. The processing illustrated in FIG. 16 corresponds to step S115 in FIG. 10. The migration instruction unit 31 initializes (sets “N”) the migration flag in the VM host information before starting the processing illustrated in FIG. 16.

The migration instruction unit 31 acquires the resource usage amounts of all the VM hosts 12 (step S701). The migration instruction unit 31, for example, acquires the resource usage amounts of all the VM hosts 12 by outputting a resource usage notification request to all the servers 1. The resource usage amounts acquired by the migration instruction unit 31 is, for example, CPU usage rate and memory usage amount. The resource usage amounts acquired by the migration instruction unit 31 may be disk I/O and network usage amount, for example.

In addition, the migration instruction unit 31 detects the VM 11 running on each VM host 12 (step S702). The migration instruction unit 31 detects the VM 11 running on each VM host 12 by outputting a request for notifying the VMID of the running VM 11 to each server 1, for example.

The power supply determination unit 22 executes power supply determination processing (step S703). In a case where the recovery flag is ON (YES in step S704), the initialization unit 30 executes initialization processing (step S705). After step S705, the processing proceeds from “B” to step S101 of FIG. 9.

In a case where the recovery flag is not ON (NO in step S704), the migration instruction unit 31 executes setting of migration (step S706). The migration instruction unit 31 sets the VM 11 running on the VM host 12 so as to migrate the VM 11 to the VM host 12 whose resource usage amount is greater than the resource usage amount of the VM host 12. For example, the migration instruction unit 31 sets the VM host 12 to be a migration source of the VM 11 in order from the VM host 12 having a small resource usage amount and sets the VM host 12 to be a migration destination of the VM 11 in order from the VM host 12 having a large resource usage amount. For example, the migration instruction unit 31 repeats processing of setting the VM host 12 having the i-th least resource usage amount as a migration source and setting the VM host 12 having the i-th largest resource usage amount as a migration destination in order from i=1.

It is assumed that the resource usage amount used in the setting of step S706 is, for example, the sum of the CPU usage rate and the memory usage amount, or one of the CPU usage rate and the memory usage amount. The resource usage amount used in the setting in step S706 may include, for example, either one or both of the disk IO and the network usage amount.

For example, the migration instruction unit 31 may set the VM host 12 as a migration source of the VM 11 in order from the VM host 12 having the smallest number of VMs 11 to run and set the VM host 12 as a migration destination of the VM 11 in order from the VM host 12 having the largest number of VMs 11 to run.

In the case of determining that the VM 11 running on the migration source VM host 12 is not movable to the migration destination VM host 12 based on the resource usage amount, the migration instruction unit 31 does not perform the above setting.

In addition, the migration instruction unit 31 sets the migration flag corresponding to the migration destination VM host 12 to Y and does not set the VM host 12 whose migration flag is Y as a migration source. By setting the migration flag, the migration destination VM 11 may not return to the migration source VM host 12 immediately after the migration.

In accordance with the setting in step S706, the migration instruction unit 31 outputs a migration instruction to the server 1 on which the VM host 12 set as a migration destination runs and the server 1 on which the VM host 12 set as a migration source runs (step S707). The migration instruction unit 31 determines whether or not all the migrations set in step S706 have been completed (step S708). In a case where all the migrations have not been completed (NO in step S708), the processing returns to step S707.

In a case where all the migrations have been completed (YES in step S708), the VM host selection unit 25 executes the stop target VM host selection processing (step S709). Then, the stop instruction unit 29 outputs an instruction to stop the stop target VM host 12 to the server 1 (step S710). The stop instruction unit 29 refers to the VM host information, for example, and outputs an instruction to stop the VM host 12 to the server 1 on which the VM host 12 whose stop target flag is “Y” runs. The stop instruction unit 29 outputs a stop instruction and returns all the stop target flags of the VM host information to “N”.

The processing in steps S709 and S710 is the same as the processing in steps S108 and S109 in FIG. 10. However, due to execution of the migration, there is a possibility that the VM host 12 having no running VM 11 may be newly generated and the VM host 12 that has not been selected as a stop target in step S108 is selected as a stop target in step S709.

As described above, since the migration instruction unit 31 migrates the VM 11 from the VM host 12 having a small resource usage amount to the VM host 12 having a large resource usage amount, it is possible to reduce the number of VM hosts 12 on which the VM 11 runs. In addition, after executing the migration, the management server 2 is stopped the VM host 12 having no running VM 11. Then, for example, in a case where the number of running VMs 11 becomes 0, the server 1 turns off the main power supply of the server 1. Therefore, the management server 2 may suppress the power consumption at the time of occurrence of a power outage and run the VM 11 for a long time by executing the migration.

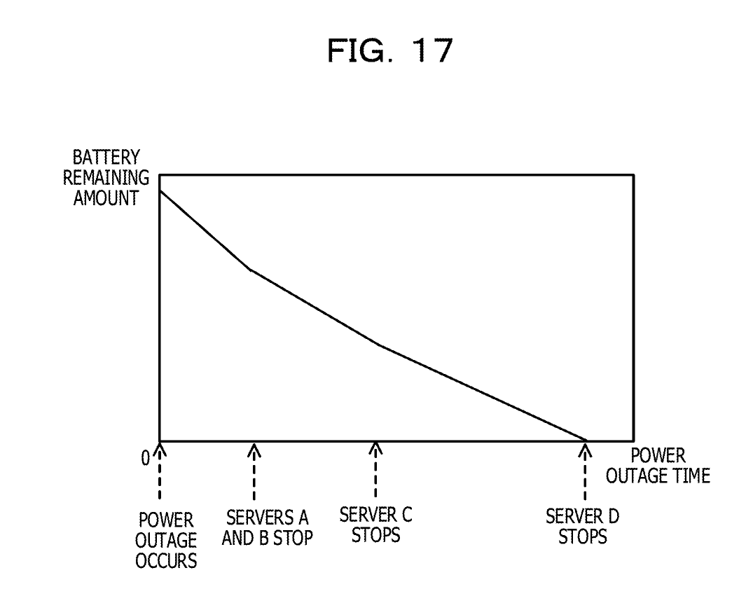

FIG. 17 is a diagram illustrating stop timing of each server 1 after occurrence of a power outage in a case where the processing of the embodiment is applied.

In the example illustrated in FIG. 17, it is assumed that a plurality of servers 1 (servers A, B, C, and D) are connected to the UPS 3 and are running by power supply from the storage battery 35 of the UPS 3 after a power outage occurs.

As described above, the management server 2 stops the VM 11 according to the priority and the like and stops the VM host 12 having no running VM 11. Furthermore, the management server 2 reduces the number of VM hosts 12 that are running by execution of migration. In a case where the VM host 12 is stopped, since the main power supply of the server 1 may be stopped, as illustrated in FIG. 17, each server 1 stops at a different timing.

In the example illustrated in FIG. 17, the servers A, B, and C stop at an earlier timing than the example illustrated in FIG. 1, but the server D stops at a later timing than the example illustrated in FIG. 1. Because the stop timing of the VM 11 having a high priority is delayed by the processing of the present embodiment, it is conceivable that the priority of the VM 11 running on the server D is high. That is, since the management server 2 may delay the stop timing of the server 1 on which the VM 11 having a high priority runs, it is possible to run the VM 11 having a high priority for a long time.

Example of Hardware Configuration of Management Server

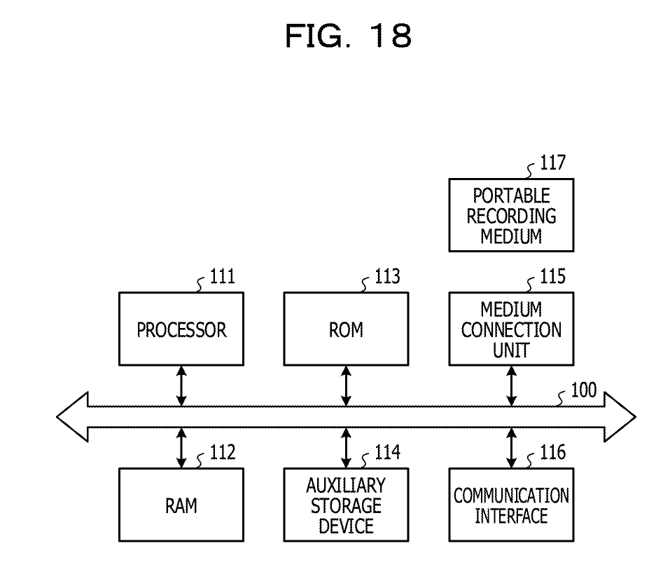

Next, an example of a hardware configuration of the management server 2 will be described with reference to the example in FIG. 18. As illustrated in the example of FIG. 18, a processor 111, a random-access memory (RAM) 112, and a read only memory (ROM) 113 are connected to a bus 100. In addition, an auxiliary storage device 114, a medium connection unit 115, and a communication interface 116 are connected to the bus 100.

The processor 111 executes the program loaded in the RAM 112. As a program to be executed, a management program that performs processing in the embodiment may be applied.

The ROM 113 is a non-volatile storage device that stores a program loaded in the RAM 112. The auxiliary storage device 114 is a storage device that stores various kinds of information, and for example, a hard disk drive, a semiconductor memory, or the like may be applied to the auxiliary storage device 114. A control program for performing the processing of the embodiment may be recorded in the auxiliary storage device 114. The medium connection unit 115 is provided so as to be connectable to a portable recording medium 117.

As the portable recording medium 117, a portable memory or an optical disc (for example, compact disc (CD), digital versatile disc (DVD)), a semiconductor memory, or the like may be applied. A management program for performing the processing of the embodiment may be recorded on the portable recording medium 117.

The storage unit 33 illustrated in FIG. 3 may be realized by the RAM 112, the ROM 113, the auxiliary storage device 114, or the like. The communication unit 21 illustrated in FIG. 3 may be realized by the communication interface 116. The power supply determination unit 22, the acquisition unit 23, the invalidation unit 24, the VM host selection unit 25, the VM selection unit 26, the calculation unit 27, the identification unit 28, the stop instruction unit 29, the initialization unit 30, the migration instruction unit 31, the setting unit 32, and the control unit 34 illustrated in FIG. 3 may be realized by the processor 111 executing a given management program.

The RAM 112, the ROM 113, the auxiliary storage device 114, and the portable recording medium 117 are examples of tangible storage media that may be read by a computer. These tangible storage media are not temporary media such as signal carriers.

Others

The present embodiment is not limited to the embodiment described above, and various configurations or embodiments may be applied within the scope not deviating from the gist of the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management apparatus for managing a plurality of information processing apparatuses, each of the plurality of information processing apparatuses being configured to run one or more virtual machines and being coupled to an uninterruptible power supply, the management apparatus comprising:
a memory; and
processor circuitry coupled to the memory and configured to
execute acquisition processing that includes acquiring a priority for each virtual machine set based on a past resource usage amount for each virtual machine in a detected time period from a storage unit in a case where it is detected that power is being supplied from a storage battery in the uninterruptible power supply to the plurality of information processing apparatuses,
execute selection processing that includes selecting a stop candidate from the virtual machines based on a current resource usage amount for each virtual machine,
execute calculation processing that includes calculating the number of the virtual machines to stop, based on a remaining amount of the storage battery,
execute identification processing that includes identifying a stop target virtual machine in accordance with the number of the virtual machines in order from the virtual machine having a lower priority among the virtual machines selected as the stop candidate, and
execute stop instruction processing that includes outputting a first instruction to a first information processing apparatus associated with the stop target virtual machine, the first instruction being configured to cause the first information processing apparatus to stop running a virtual machine identified as the stop target virtual machine.

2. The management apparatus according to claim 1,
wherein the stop instruction processing includes outputting a second instruction to the first information processing apparatus when it is detected that power is being supplied from the storage battery in the uninterruptible power supply to the first information processing apparatus, the second instruction being configured to cause the first information processing apparatus to stop running a virtual machine host having no running virtual machine.

3. The management apparatus according to claim 1,
wherein the processor circuitry is further configured to execute migration instruction processing that includes acquiring a resource usage for each virtual machine host to output an instruction to migrate a virtual machine running on a first virtual machine host to a second virtual machine host, a resource usage amount of which is greater than a resource usage amount of the first virtual machine host, to the first information processing apparatus, in a case where it is detected that power is being supplied from the storage battery in the uninterruptible power supply to the first information processing apparatus, and
wherein the stop instruction processing is configured to output a second instruction to the first information processing apparatus after the migration instruction processing outputs a third instruction to the first information processing apparatus, the second instruction being configured to cause the first information processing apparatus to stop a virtual machine host having no running virtual machine, the third instruction being configured to cause the first information processing to perform a migration of the virtual machine.

4. The management apparatus according to claim 3,
wherein the migration instruction processing is configured to set a virtual machine host as the first virtual machine host that is a migration source of the virtual machine in ascending order according to a resource usage amount of the virtual machine host and set a virtual machine host as the second virtual machine host that is a migration destination of the virtual machine in descending order according to a resource usage amount of the virtual machine host.

5. The management apparatus according to claim 3,
wherein the processor circuitry is further configured to execute invalidation processing that includes outputting an instruction to invalidate a load distribution function of the information processing apparatus to the information processing apparatus before the migration instruction processing outputs an instruction to migrate the virtual machine to the information processing apparatus.

6. A method for managing a plurality of information processing apparatuses, each of the plurality of information processing apparatuses being configured to run one or more virtual machines and being coupled to an uninterruptible power supply, the method comprising:
executing acquisition processing that includes acquiring a priority for each virtual machine set based on a past resource usage amount for each virtual machine in a detected time period from a storage unit in a case where it is detected that power is being supplied from a storage battery in the uninterruptible power supply to the plurality of information processing apparatuses;
executing selection processing that includes selecting a stop candidate from the virtual machines based on a current resource usage amount for each virtual machine;
executing calculation processing that includes calculating the number of the virtual machines to stop, based on a remaining amount of the storage battery;
executing identification processing that includes identifying a stop target virtual machine in accordance with the number of the virtual machines in order from the virtual machine having a lower priority among the virtual machines selected as the stop candidate; and
executing stop instruction processing that includes outputting a first instruction to a first information processing apparatus associated with the stop target virtual machine, the first instruction being configured to cause the first information processing apparatus to stop running a virtual machine identified as the stop target virtual machine.

7. The method according to claim 6,
wherein the stop instruction processing includes outputting a second instruction to the first information processing apparatus when it is detected that power is being supplied from the storage battery in the uninterruptible power supply to the first information processing apparatus, the second instruction being configured to cause the first information processing apparatus to stop running a virtual machine host having no running virtual machine.

8. The method according to claim 6, further comprising:
executing migration instruction processing that includes acquiring a resource usage for each virtual machine host to output an instruction to migrate a virtual machine running on a first virtual machine host to a second virtual machine host, a resource usage amount of which is greater than a resource usage amount of the first virtual machine host, to the first information processing apparatus, in a case where it is detected that power is being supplied from the storage battery in the uninterruptible power supply to the first information processing apparatus, and
wherein the stop instruction processing is configured to output a second instruction to the first information processing apparatus after the migration instruction processing outputs a third instruction to the first information processing apparatus, the second instruction being configured to cause the first information processing apparatus to stop a virtual machine host having no running virtual machine, the third instruction being configured to cause the first information processing to perform a migration of the virtual machine.

9. The method according to claim 8,
wherein the migration instruction processing is configured to set a virtual machine host as the first virtual machine host that is a migration source of the virtual machine in ascending order according to a resource usage amount of the virtual machine host and set a virtual machine host as the second virtual machine host that is a migration destination of the virtual machine in descending order according to a resource usage amount of the virtual machine host.

10. The method according to claim 8, further comprising:
executing invalidation processing that includes outputting an instruction to invalidate a load distribution function of the information processing apparatus to the information processing apparatus before the migration instruction processing outputs an instruction to migrate the virtual machine to the information processing apparatus.

11. A non-transitory computer-readable storage medium for storing a program which causes a processor to perform processing for managing a plurality of information processing apparatuses, each of the plurality of information processing apparatuses being configured to run one or more virtual machines and being coupled to an uninterruptible power supply, the processing comprising:
executing acquisition processing that includes acquiring a priority for each virtual machine set based on a past resource usage amount for each virtual machine in a detected time period from a storage unit in a case where it is detected that power is being supplied from a storage battery in the uninterruptible power supply to the plurality of information processing apparatuses,
executing selection processing that includes selecting a stop candidate from the virtual machines based on a current resource usage amount for each virtual machine,
executing calculation processing that includes calculating the number of the virtual machines to stop, based on a remaining amount of the storage battery,
executing identification processing that includes identifying a stop target virtual machine in accordance with the number of the virtual machines in order from the virtual machine having a lower priority among the virtual machines selected as the stop candidate, and
executing stop instruction processing that includes outputting a first instruction to a first information processing apparatus associated with the stop target virtual machine, the first instruction being configured to cause the first information processing apparatus to stop running a virtual machine identified as the stop target virtual machine.

12. The non-transitory computer-readable storage medium according to claim 11,
wherein the stop instruction processing includes outputting a second instruction to the first information processing apparatus when it is detected that power is being supplied from the storage battery in the uninterruptible power supply to the first information processing apparatus, the second instruction being configured to cause the first information processing apparatus to stop running a virtual machine host having no running virtual machine.

13. The non-transitory computer-readable storage medium according to claim 11,
wherein the processing further comprises executing migration instruction processing that includes acquiring a resource usage for each virtual machine host to output an instruction to migrate a virtual machine running on a first virtual machine host to a second virtual machine host, a resource usage amount of which is greater than a resource usage amount of the first virtual machine host, to the first information processing apparatus, in a case where it is detected that power is being supplied from the storage battery in the uninterruptible power supply to the first information processing apparatus, and
wherein the stop instruction processing is configured to output a second instruction to the first information processing apparatus after the migration instruction processing outputs a third instruction to the first information processing apparatus, the second instruction being configured to cause the first information processing apparatus to stop a virtual machine host having no running virtual machine, the third instruction being configured to cause the first information processing to perform a migration of the virtual machine.

14. The non-transitory computer-readable storage medium according to claim 13,
wherein the migration instruction processing is configured to set a virtual machine host as the first virtual machine host that is a migration source of the virtual machine in ascending order according to a resource usage amount of the virtual machine host and set a virtual machine host as the second virtual machine host that is a migration destination of the virtual machine in descending order according to a resource usage amount of the virtual machine host.

15. The non-transitory computer-readable storage medium according to claim 13,
wherein the processing further comprises: executing invalidation processing that includes outputting an instruction to invalidate a load distribution function of the information processing apparatus to the information processing apparatus before the migration instruction processing outputs an instruction to migrate the virtual machine to the information processing apparatus.
